(19) United States
(12) Patent Application Publication
(10) Pub. No.: US 2007/0211317 A1
(43) Pub. Date: Sep. 13, 2007

(54) Security Element with a Color Shift Tilt Effect

(76) Inventor: Manfred Heim, Munchen (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/630,702

(22) PCT Filed: Jun. 15, 2005
(86) PCT No.: PCT/EP05/06378

§ 371 Date: Dec. 20, 2006

(30) Foreign Application Priority Data
Jul. 5, 2004 (DE) 10 2004 032 565.0

(51) Int. Cl. G03H 1/00

(52) U.S. Cl. 359/2

(57) ABSTRACT

The present invention relates to a security element for security papers, value documents and the like, having a thin-film element (22), with color-shift effect, that exhibits a reflection layer (26), an absorber layer (28) and a spacing layer (24) disposed between the reflection layer (26) and the absorber layer (28). According to the present invention, the spacing layer is formed by an ultra-thin foil (24) having a thickness below 1.0 μm.

The present invention relates to a security element for security papers, value documents and the like, having a thin-film element, with color-shift effect, that exhibits a reflection layer, an absorber layer and a spacing layer disposed between the reflection layer and the absorber layer. The present invention also relates to a security paper, a value document and a method for manufacturing such a security element.

Value documents, such as banknotes, stocks, bonds, certificates, vouchers, checks, valuable admission tickets and other papers that are at risk of counterfeiting, such as passports and other identitification documents, are normally provided with various security features to increase their counterfeit security. The security features can be developed, for example, in the form of a security thread embedded in a banknote, an applied security strip or a self-supporting transfer element, such as a patch or a label that, after its manufacture, is applied to a value document. According to the present invention, security paper is understood to be the not yet circulatable precursor to the value document.

Furthermore, it is known to use security features having multi-layer thin-film elements that likewise display a color-shift effect. As security features were used, for example, foils coated with cholesteric liquid crystals in which the color impression for the viewer changes with the viewing angle, and when the security feature is tilted, shifts for example from green to blue, from blue to magenta or from magenta to green. The color impression of these liquid crystal-coated foils can also be influenced after completion of the foil by means of stretching. The color effect is based on interference effects due to multiple reflections in the different sub-layers of the thin-film element and is described in detail in, for example, publication EP 0 395 410 B1. Such color changes upon tilting a security feature are referred to in the following as color-shift effects.

As the layer that is mainly responsible for the color effect, the thin-film elements include an ultra-thin dielectric layer that is typically disposed between an absorber layer and a reflection layer. The key technological challenge here is the manufacture of the dielectric layer, which is just a few hundred nanometers thick.

Currently, the thin dielectric layers are normally produced through a complex physical vapor deposition process. Particularly in the large-area coatings required in the security paper and banknote segment, the precision requirements are extraordinarily high, such that such coatings can be carried out in only a few locations worldwide.

Based on that, the object of the present invention is to specify a generic security element that is easier and cheaper to manufacture compared with the background art.

This object is solved by the security element having the features of the main claim. A security paper for the manufacture of security documents, a value document having such a security element and a manufacturing method for such a security element are the subject of the coordinated claims. Developments of the present invention are the subject of the dependent claims.

According to the present invention, the spacing layer in a security element of the kind mentioned above is formed by an ultra-thin foil having a thickness below 1.0 μm. The ultra-thin foil preferably exhibits a thickness of about 250 nm to about 750 nm, preferably of about 400 nm to about 600 nm. Such foils are already commercially available today and are used mainly as dielectric foils for capacitors.

According to an advantageous development of the present invention, the ultra-thin foil constitutes a stretched polyester foil, preferably a monoaxially, sequentially biaxially or simultaneously biaxially stretched polyalkylene terephthalate foil. In particular, the foil can be a biaxially stretched polyethylene terephthalate (PET) foil. Here, the stretching of the PET foils increases their stability and heat resistance and improves further properties of the foils, such as their dimensional stability.

In preferred embodiments, the reflection layer of the thin-film element is formed by an opaque metal layer. Here, particularly metal coatings comprising aluminum, silver, nickel, copper, iron, chrome or gold, as well as other strongly reflective metals may be used.

Instead of as a substantially opaque element, the security element can also be formed as a semitransparent see-through security element. In this case, as the reflection layer, instead of an opaque reflection layer, an absorber layer, a semitransparent metal layer or a transparent reflection layer is used whose refractive index is different from that of the ultra-thin foil. For such a transparent reflection layer, practically all vapor-depositable, transparent compounds may be used, especially also higher-index coating materials such as ZrO₂, ZnS, TiO₂ and ITO (indium tin oxide), whose refractive index differs from that of the foil by more than 0.2, preferably even by more than 0.5. The layer thickness of such a transparent reflection layer preferably lies in the range from 30 nm to 300 nm, particularly preferably between about 50 nm and about 60 nm.

As absorber layers, metal layers comprising materials such as chrome, iron, gold, copper aluminum or titanium that are preferably applied in a thickness of about 4 nm to about 20 nm can advantageously be used. Also compounds such as nickel-chrome-iron, or rarer metals such as vanadium, palladium or molybdenum can be used. Further suitable materials include, for example, nickel, cobalt, tungsten, niobium, aluminum, metal compounds such as metal fluorides, metal oxides, metal sulfides, metal nitrides, metal carbides, metal phosphides, metal selenides, metal silicides and compounds thereof, as well as carbon, germanium, cermet, iron oxide and the like.

The absorber layer and the reflection layer are preferably applied to the ultra-thin foil in a vacuum evaporation method. Here, a wide variety of evaporation methods can be used for coating the foil.

Physical vapor deposition (PVD) methods such as boat evaporation, evaporation by resistance or induction heating, AC and DC sputtering, and electron beam or arc evaporation form one group. As a further group, CVD (chemical vapor deposition) methods such as reactive plasma sputtering or other plasma-assisted vapor deposition methods may be used.

In an advantageous development of the present invention, it is provided that the absorber layer and/or the spacing layer exhibits gaps in the form of patterns, characters or codes in which no color-shift effect is perceptible. Alternatively or additionally, the reflection layer, too, can exhibit gaps in the form of patterns, characters or codes that appear as transparent or semitransparent areas in the thin-film element. The gaps can be applied as, for example, graphic designs or as positive or negative lettering, for instance in the form of a serial number or another individualizing mark, and further increase the counterfeit security of the security element.

To obtain a double-sided thin-film element having a color-shift effect that is visible from both sides, the thin-film element can exhibit a second absorber layer on the side of the reflection layer facing away from the spacing layer and, disposed between the second absorber layer and the reflection layer, a second spacing layer comprising an ultra-thin foil having a thickness below 1.0 μm.

For this second ultra-thin foil, the explanations given above for the first ultra-thin foil apply accordingly. In an advantageous embodiment, the first and second spacing layer are formed from foils of differing thickness such that different color-shift effects are perceptible from the two sides of the security element.

Further, it can be provided that the thin-film element exhibits at least one further layer having an additional security feature, especially a layer provided with magnetic, electrically conductive, luminescent or optically variable substances. For example, a magnetic metal layer suitable and intended for machine-readable codes and comprising nickel, iron, cobalt or a suitable alloy can be disposed between the reflection layer and a substrate of the security element in such a way that it remains invisible for the viewer and does not negatively impact the described optical effects.

To facilitate the further processing of the coated ultra-thin foil, the thin-film element is advantageously applied on a substrate, for example a transparent substrate foil. The transparency and/or color of the substrate are expediently coordinated with the properties of the thin-film element and the desired appearance of the security element. For example, a transparent substrate is suitable for see-through security elements or for security elements that are provided with gaps and whose information content is intended to be visible also in transmitted light. In some embodiments it can be provided that the substrate is removed, for example via suitable release layers, after the application of the security element to its destination.

Since the color impression of the security element depends on the local thickness of the foil, thickness variations in the foil can result in a non-uniform color impression. To compensate for this effect, the thin-film element can be stretched in some areas upon application to the substrate in order to compensate for thickness variations in the unstretched foil. The compensation can occur, for instance, with the aid of a control loop in which the thickness or the color impression of the foil is detected during the application of the foil and the magnitude of the elongation is regulated accordingly.

The elongation can also be used specifically to vary the color in that the foil is laminated, for example, along the direction of application with slowly increasing or decreasing elongation such that a continuous color transition is created.

According to a further advantageous development of the present invention, the thin-film element is provided with an areal diffraction pattern to form a color-shift hologram in which the color-shift effect is combined with a holographic effect. For this, the thin-film element is preferably disposed on a substrate that already exhibits an areal diffraction pattern. Alternatively to this, it is also possible to subsequently emboss the diffraction pattern in the thin-film element.

For example, the substrate can be formed by an embossing lacquer layer that is provided with a diffraction pattern and that forms a component of the finished security element. The diffraction pattern of the embossing lacquer layer is evaporated with a reflector, and the semitransparent thin-film element having the layer structure semitransparent metal/ultra-thin foil/semitransparent metal can be affixed on top of this. The absorber layer of such a color-shift hologram typically exhibits a transmission of between 25% and 75%.

An alternative layer structure for a security element provided with diffraction patterns is as follows: A substrate provided with diffraction patterns is provided with a semitransparent metal layer, on top of which an adhesive layer is applied. On top of the adhesive layer, an absorber is applied, then the ultra-thin foil and then a reflection layer.

Each of the above-described security elements can be designed, for example, in the form of a security strip, a security thread, a security band, an individual tag-shaped element (patch) or a transfer element for application to a security paper, value document or the like. In addition, the security element can be present in the form of pigments that are manufactured, for example, by grinding the thin-film structure according to the present invention. With suitable binders, these pigments can also be further processed into printing inks.

The present invention also includes a security paper for manufacturing security documents, such as banknotes, identification cards and the like, that is furnished with a security element of the kind described above. The security paper can especially include at least one through window area or a hole that is covered with the security element. In this case, advantageously, a security element is used whose reflection layer is provided with gaps, or a security element whose color-shift effects are visible from both sides.

The present invention further includes a value document, for example a banknote, that is furnished with an above-described security element. The value document can likewise include a window area covered with the security element or a hole covered therewith.

The security element, security paper or value document described can also be used for securing goods of any kind.

According to the present invention, for manufacturing a security element for security papers, value documents and the like that includes a thin-film element, with color-shift effect, that exhibits a reflection layer, an absorber layer and a spacing layer disposed between the reflection layer and the absorber layer, it is provided that the spacing layer is formed by an ultra-thin foil having a thickness below 1.0 μm that is coated on opposing main surfaces with the reflection layer and the absorber layer. The reflection layer and/or the absorber layer are preferably vapor deposited on the ultra-thin foil. Here, the reflection layer can be designed as described above, i.e. advantageously as an opaque metal layer, as a semitransparent metal layer, as a transparent reflection layer or as an absorber layer.

In a development of the method, gaps in the form of patterns, characters or codes are introduced into the thin-film element, preferably into the absorber and/or reflection layer. This can occur particularly in the manner described below with the aid of oil.

For further processing, the thin-film element is expediently applied to a substrate, for example a transparent substrate foil. Alternatively, the coated ultra-thin foil can be applied directly to a security paper or a value document. As mentioned, it can be advantageous to stretch the foil in some areas upon application to a substrate or an object to compensate for thickness variations in the foil.

Further exemplary embodiments and advantages of the present invention are explained below by reference to the drawings, in which a depiction to scale and proportion was omitted in order to improve their clarity.

Shown are:

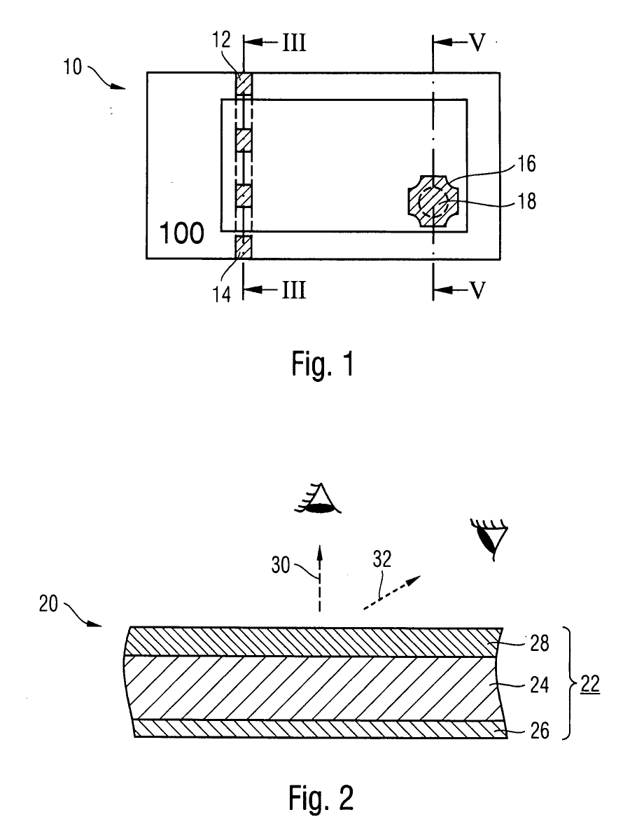

FIG. 1 a schematic diagram of a banknote having an embedded color-shift security thread and affixed color-shift transfer element, each according to an exemplary embodiment of the present invention,

FIG. 2 a color-shift security element according to an exemplary embodiment of the present invention, in cross section,

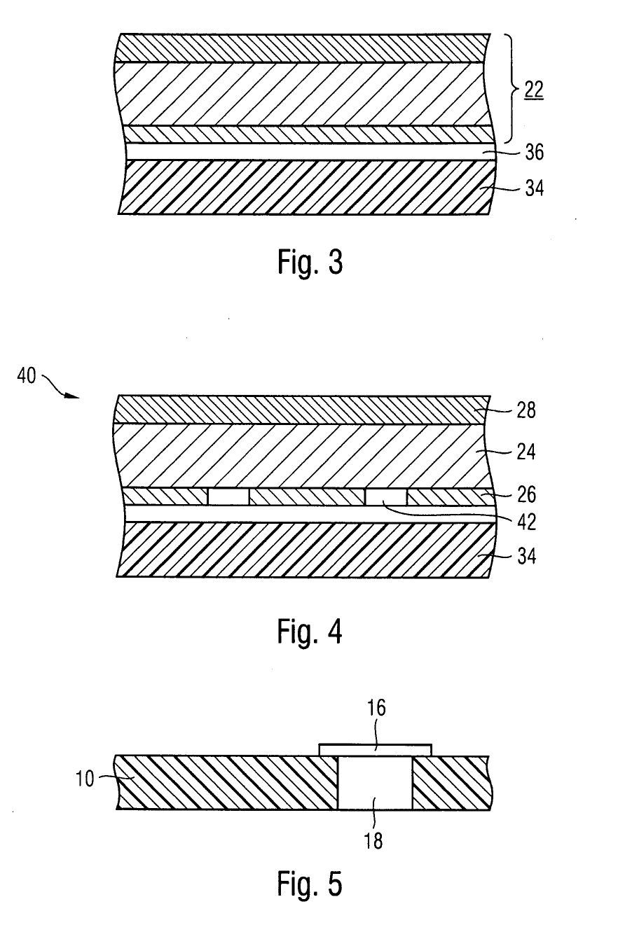

FIG. 3 a cross section through the color-shift security thread in FIG. 1 along the line III-III,

FIG. 4 a further exemplary embodiment of a security element according to the present invention, having gaps in the reflection layer,

FIG. 5 a cross section through the banknote and the color-shift transfer element in FIG. 1 along the line V-V,

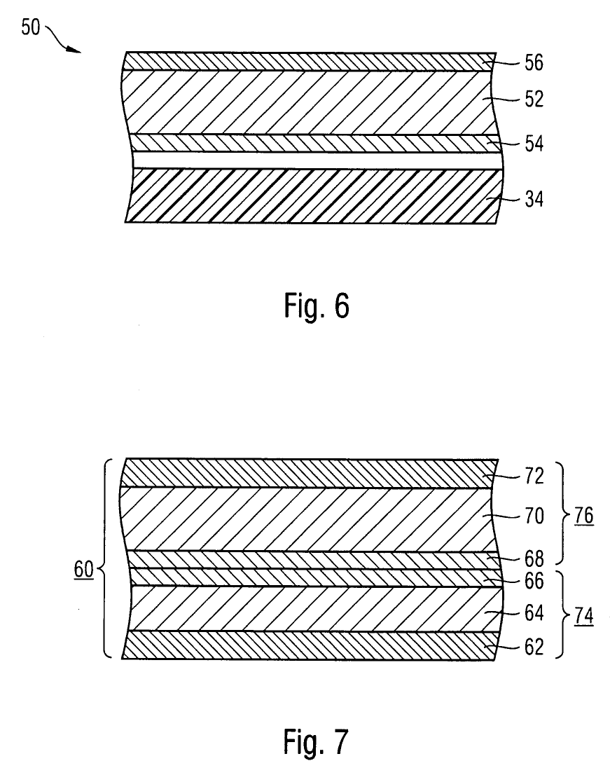

FIG. 6 a semitransparent see-through security element according to a further exemplary embodiment of the present invention,

FIG. 7 a double-sided thin-film element according to a further exemplary embodiment of the present invention,

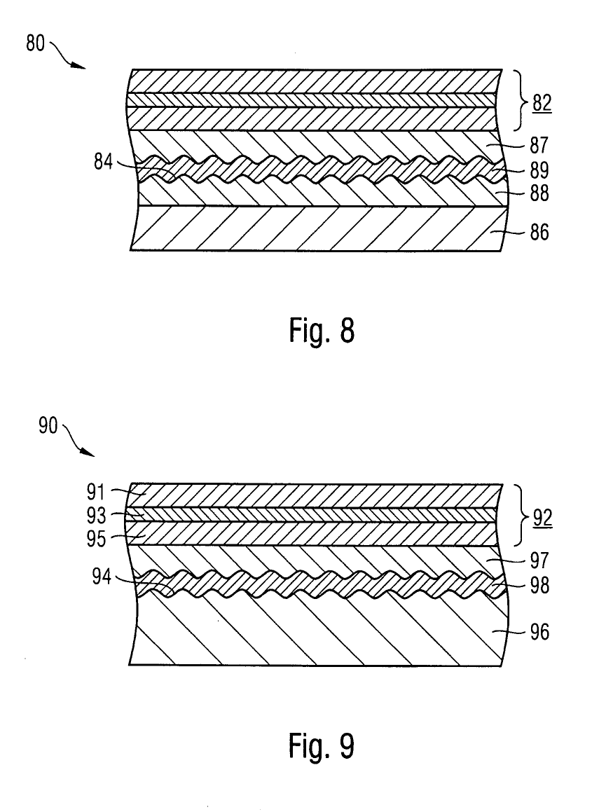

FIG. 8 a color-shift hologram according to an exemplary embodiment of the present invention, in cross section, and

FIG. 9 a further color-shift hologram according to an exemplary embodiment of the present invention, in cross section.

The invention will now be explained using a banknote as an example. FIG. 1 shows a schematic diagram of a banknote 10 that is provided with an embedded color-shift security thread 12 and an affixed color-shift transfer element 16. The security thread 12 emerges at certain window areas 14 on the surface of the banknote 10, while it is embedded in the interior of the banknote 10 in the areas lying therebetween. In the window areas 14, the security thread 12 displays a color-shift effect that gives the viewer a color impression that changes with the viewing angle.

In the exemplary embodiment, the banknote 10 exhibits a through, diecut opening 18 that, on the front side of the banknote, is completely covered by the color-shift transfer element 16. Alternatively, the opening could also have already been worked in when the paper was manufactured. The color-shift transfer element 16 is formed in the manner described below as a semitransparent see-through security element that, in the see-through area 18, displays a color-shift effect from both sides of the banknote.

First, the general layer structure of security elements according to the present invention is explained with reference to the cross-sectional illustrations in FIG. 2 to 4.

The security element 20 in FIG. 2 includes a thin-film element 22, with color-shift effect, that comprises a 0.5 μm thick BOPET (biaxially oriented polyethylene terephthalate) foil 24 coated on both sides. The ultra-thin BOPET foil 24 is evaporated on one side with an opaque reflection layer 26 comprising aluminum, and on the other side with a semitransparent absorber layer 28 comprising chrome. As already explained above, due to multiple interferences in the thin-film element 22, a viewing-angle-dependent color impression results when the security element is viewed from the semitransparent absorber layer 28 side. For example, the security element 20 appears in magenta when viewed vertically 30, while it appears green when viewed from an acute angle 32.

The thin-film element 22 in FIG. 2 can be applied directly to a value document, such as a banknote. Normally, however, for further processing, the coated ultra-thin foils are applied to a substrate, for example a transparent substrate foil. For this, FIG. 3 shows a cross section through a security thread, like the window security thread 12 in FIG. 1. For its manufacture, first, the large-areally coated BOPET foil 24 was laminated onto a substrate foil 34 such that it is joined therewith via an adhesive layer 36. The substrate foil and thin-film element were then cut into narrow strips to obtain a plurality of color-shift security threads. Prior to cutting, a diffraction pattern can additionally be embossed in the overall structure. The embossment can occur on the side bearing the thin-film element or also on the substrate foil side.

The security elements according to the present invention can be provided with gaps 42 in the form of patterns, characters or codes, as shown in the security element 40 in FIG. 4. For this, when coating the ultra-thin foil 24 with the reflection layer 26 for example, an endless masking tape is allowed to run over the coating cylinder simultaneously and synchronously with the foil. Here, in the evaporation zone, the masking tape lies with tensioning firmly on the foil 24 and the coating cylinder such that a sharp transition from metal-coated and uncoated areas can be created on the foil 24.

To prevent metal vapor deposits on the masking tape, said tape is evaporated with oil prior to each inlet into the evaporation zone. After passing the evaporation zone, the deposited oil is removed from the masking tape again by a heater such that no thick and uneven oil film can accumulate on the masking tape. For further details of the manufacture of metal-free strips in metal evaporation, reference is made to publication EP 0 756 020 B1, whose disclosure in this respect is incorporated in the present application.

In a further alternative method, immediately prior to the evaporation step with metal, the foil can be printed on with a volatile oil at the sites at which gaps are to appear in the metal layer. During the evaporation step with metal, the oil evaporates at the coated sites on the foil such that no metal vapor settles there.

Alternatively, the gaps can also be created according to the method described in publication EP 1 023 499 B1. Its disclosure in this respect is likewise incorporated in the present application.

In the areas of the gaps 42 in the otherwise opaque reflection layer 26, the thin-film element is transparent or semitransparent such that, in these areas, the viewer is presented with a striking contrast to the surrounding color-shift effect. For example, the patterns, characters or codes can light up brightly in transmitted light when the thin-film element 22 is applied to a transparent substrate 34.

For this, FIG. 5 shows a section of the banknote 10 in FIG. 1 along the line V-V. On the front, the diecut opening 18 of the banknote is completely covered by the color-shift transfer element 16. The transfer element 16 can be formed, for example, like the security element 40 in FIG. 4 and be provided with gaps, for instance in the form of a serial number or value number. In reflected light, the color-shift effect of the transfer element 16 then determines the appearance, while in transmitted light, the uncovered serial number or value number of the banknote stands out conspicuously.

FIG. 6 shows a further embodiment of the color-shift transfer element 16 according to the present invention, in the form of a semitransparent see-through security element 50 that likewise can be applied over the opening 18 of a banknote 10. The see-through security element 50 includes an ultra-thin foil 52 laminated onto a transparent substrate foil 34, in the exemplary embodiment having a thickness of 0.6 μm, in which the reflection layer 54 is formed by a semitransparent metal layer. Both the absorber layer 56 and the reflection layer 54 each transmit and reflect a portion of the incident radiation such that the see-through security element 50 appears semitransparent and displays a color-shift effect on both sides. Also the see-through security element 50 can, of course, be provided with gaps of the kind described above. The see-through element can additionally exhibit a diffraction pattern that was embossed subsequently. The embossment can occur on the side bearing the thin-film element or on the substrate foil side.

A further exemplary embodiment having a color-shift effect that is visible from both sides is illustrated in FIG. 7. The thin-film element 60 shown without a substrate foil in the figure exhibits a first absorber layer 62, a first ultra-thin foil 64, opaque reflection layers 66 and 68, a second ultra-thin foil 70 and a second absorber layer 72. For manufacturing, the thin-film element 60 is formed from two coated foils 74 and 76 whose opaque reflection layers 66, 68 face each other. Viewed from the bottom, then, only the color-shift effect of the first coated foil 74 is visible, and from the top, only the color-shift effect of the second coated foil 76. The thicknesses of the ultra-thin foils 64 and 70 can be chosen to be different from one another such that different color-shift effects result on the two sides of the security element 60.

In manufacturing such a double-sided thin-film element 60, the first ultra-thin foil 74 can be laminated with its absorber layer ahead on a transparent substrate foil and the second foil 76 then laminated with its reflection layer ahead on top of the first foil 74.

Alternatively, the two ultra-thin foils 74 and 76 can each be laminated with the reflection layer ahead onto opposing main surfaces of a substrate foil. In this case, the substrate foil must not be transparent, but instead can be, for example, suitably colored such that its own color stands out in some areas in gaps in the reflection layers 66 and 68.

These double-sided thin-film elements, particularly with the same color effect on the opposing main surfaces, are especially well suited for further processing into pigments. For this, the thin-film elements are ground into the desired pigment size and, if applicable, further processed into printing inks.

The security element 80 of the exemplary embodiment shown in FIG. 8 constitutes a color-shift hologram in which the thin-film element 82 with color-shift effect is additionally combined with an areal diffraction pattern 84. For this, an embossing lacquer layer 88 is applied on a substrate foil 86 in which the diffraction pattern 84 is embossed. On top of the embossing lacquer layer, an opaque metal layer is vapor deposited as a reflection layer 89. The thin-film element 82 that is formed to be semitransparent as, for example, in FIG. 2, is applied to the reflection layer 89 by means of adhesive 87 such that the diffraction pattern 84 can be viewed through the thin-film element 82. When viewed, the security element 80 then shows a holographic effect combined with a color-shift effect.

The security element 90 of the exemplary embodiment shown in FIG. 9 likewise constitutes a color-shift hologram in which the thin-film element 92 with color-shift effect is additionally combined with an areal diffraction pattern 94. For this, a diffraction pattern 94 was embossed directly in a substrate foil 96. A semitransparent metal layer 98 was vapor deposited on the diffraction pattern 94. The thin-film element 92 was applied to the semitransparent metal layer by means of an adhesive 97. Here, the thin-film element comprises the layers absorber 95, ultra-thin foil 93 and opaque metal layer as the reflection layer 91. When viewed through the preferably transparent substrate foil, the viewer simultaneously sees a holographic effect combined with a color-shift effect.

1. A security element for security papers, value documents and the like having a thin-film element, with color-shift effect, comprising a reflection layer, an absorber layer and a spacing layer disposed between the reflection layer and the absorber layer, wherein the spacing layer is formed by an ultra-thin foil having a thickness below 1.0 μm.

2. The security element according to claim 1, wherein the ultra-thin foil has a thickness of about 250 nm to about 750 nm, preferably of about 400 nm to about 600 nm.

3. The security element according to claim 1, wherein the ultra-thin foil comprises a stretched polyester foil, preferably a monoaxially, sequentially biaxially or simultaneously biaxially stretched polyalkylene terephthalate foil, particularly preferably a biaxially stretched polyethylene terephthalate foil.

4. The security element according to claim 1, wherein the reflection layer is formed by an opaque metal layer.

5. The security element according to claim 1, wherein the reflection layer is formed by a semitransparent metal layer.

6. The security element according to claim 1, wherein the reflection layer and/or absorber layer is formed by a transparent reflection layer that exhibits a different refraction index from the ultra-thin foil.

7. The security element according to claim 1, wherein the reflection layer and absorber layer are each formed by a semitransparent metal layer of identical or different material having in each case a transmission between 25% and 75% in the visible spectral range.

8. The security element according to claim 1, wherein the reflection layer is vapor deposited on the ultra-thin foil.

9. The security element according to claim 1, wherein the absorber layer is vapor deposited on the ultra-thin foil, especially in that the reflection layer and the absorber layer are vapor deposited on opposing main surfaces of the ultra-thin foil.

10. The security element according to claim 1, wherein the absorber layer and/or the spacing layer exhibits gaps in the form of patterns, characters or codes in which no color-shift effect is perceptible.

11. The security element according to claim 1, wherein the reflection layer exhibits gaps in the form of patterns, characters or codes that form transparent or semitransparent areas in the thin-film element.

12. The security element according to claim 1, wherein the thin-film element comprises a second absorber layer on the side of the reflection layer facing away from the spacing layer and, disposed between the second absorber layer and the reflection layer, a second spacing layer comprising an ultra-thin foil having a thickness below 1.0 μm, forming a double-sided thin-film element with color-shift effects that are visible from both sides.

13. The security element according to claim 12, wherein the second spacing layer is formed from an ultra-thin foil according to claim 2.

14. The security element according to claim 12, wherein the first and second spacing layer are formed from foils of differing thickness such that different color-shift effects are perceptible from the two sides of the security element.

15. The security element according to claim 1, wherein the thin-film element comprises at least one further layer having a security feature, especially a layer provided with magnetic, electrically conductive, luminescent or optically variable substances.

16. The security element according to claim 1, wherein the thin-film element is applied on a substrate, especially a transparent substrate foil.

17. The security element according to claim 16, wherein the thin-film element on the substrate is applied stretched in some areas to compensate for thickness variations in the unstretched foil.

18. The security element according to claim 17, wherein the thin-film element is provided with an areal diffraction pattern.

19. The security element according to claim 18, wherein the areal diffraction pattern is formed by an embossing pattern.

20. The security element according to at claim 1, wherein the security element forms a security strip, a security thread, a security band, a patch or a transfer element for application to a security paper, value document and the like.

21. A security paper for manufacturing security documents, such as banknotes, identity cards or the like, that is furnished with a security element according to claim 1.

22. The security paper according to claim 21 having at least one window area or hole that is covered with the security element.

23. A value document, such as a banknote, identification card or the like, that is furnished with a security element according to claim 1.

24. The value document according to claim 23 having at least one window area or hole that is covered with the security element.

25. (canceled)

26. A method of manufacturing a security element for security papers, value documents and the like that includes a thin-film element, with color-shift effect, that comprising forming said security element from layers comprising a reflection layer, an absorber layer and a spacing layer disposed between the reflection layer and the absorber layer, wherein the spacing layer is being formed by an ultra-thin foil having a thickness below 1.0 μm that is coated on opposing main surfaces with the reflection layer and the absorber layer.

27. The method according to claim 26, wherein the reflection layer and/or the absorber layer are vapor deposited on the ultra-thin foil.

28. The method according to one of claim 26, wherein gaps in the form of patterns, characters or codes are introduced into the thin-film element, preferably into the absorber and/or reflection layer.

29. The method according to claim 28, wherein the ultra-thin foil is, covered in the gap areas with a firmly seated masking tape during evaporation, and the masking tape is coated with oil prior to evaporation to prevent the deposit of metal vapor on the masking tape.

30. The method according to claim 28, wherein the ultra-thin foil is printed on with oil in the gap areas prior to evaporation.

31. The method according to claim 26, wherein the ultra-thin foil is provided with at least one further layer having a security feature, especially with a layer containing magnetic, electrically conductive, luminescent or optically variable substances.

32. The method according to claim 26, wherein the thin-film element is applied to a substrate, especially a transparent substrate foil.

33. The method according to claim 26, wherein the thin-film element is applied directly to a security paper or a value document.

34. The method according to claim 32, wherein the thin-film element is applied stretched in some areas on the substrate, the security paper or the value document to compensate for thickness fluctuations in the unstretched foil.

35. The method according to claim 34, wherein the local thickness is detected upon application of the foil, and the elongation of the foil is regulated based on the detected thickness in order to compensate for thickness variations in the unstretched foil.

36. The method according to claim 34, wherein, upon application of the foil, the local thickness is detected via a measurement of the reflected color, and the elongation of the foil is regulated based on the detected thickness.

37. The method according to claim 26, wherein the thin-film element is applied to a substrate having an areal diffraction pattern.

38. The method according to claim 26, wherein diffraction patterns are embossed in the thin-film element.

39. A printing ink comprising a security element according to claim 1 in the form of a pigment.
